(19) United States
(12) Patent Application Publication
(10) Pub. No.: US 2003/0217218 A1
(43) Pub. Date: Nov. 20, 2003

(54) Interface for devices having different data bus widths and data transfer method using the interface

(75) Inventor: Vladimir Gaidukov, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/309,108

(22) Filed: Dec. 4, 2002

(30) Foreign Application Priority Data
May 20, 2002 (KR) 2002-27927

(51) Int. Cl. G06F 13/40

(52) U.S. Cl. 710/307

(57) ABSTRACT

An interface for interfacing a plurality of first data buses each having an N-bit data width and a second data bus having a 2N-bit data width. The interface includes a selection circuit and first and second conversion circuits. The selection circuit outputs the data on a data bus selected from the first data buses in response to a selection signal. The first conversion circuit pre-fetches first and second N-bit data on the selected data bus in response to a read control signal and transfers 2N-bit data comprised of the pre-fetched first and second N-bit data to the second data bus. The second conversion circuit converts the 2N-bit data on the second data bus into N-bit data in response to a write control signal and transfers the N-bit data to a data bus selected from the first data buses.

### CROSS-REFERENCE TO RELATED APPLICATIONS

This application claims the benefit of Korean Application No. 2002-27927 filed May 20, 2002, in the Korean Intellectual Property Office, the disclosure of which is incorporated herein by reference.

### BACKGROUND OF THE INVENTION

1. Field of the Invention

The present invention relates to an interface in a data processing system, particularly, to an interface for devices having different data bus widths and a data transfer method using the interface. More particularly, the present invention relates to interfacing a host data bus of a 2N-bit data width and a peripheral data bus of an N-bit data width.

2. Description of the Related Art

In many data processing systems, the architecture of an embedded microprocessor system (embedded controller) and the hardware-wise design of the data processing system (sub-systems) are based on 32-bit microprocessors and a 32-bit system bus. For example, IBM, Motorola power PC series, Intel 80960 and MIPS 32 series use 32-bit microprocessors and a 32-bit system bus.

Most sub-systems, such as peripherals and memory, can be connected to a 32-bit system bus without additional logics. For example, bus width of a memory sub-system can be adjusted according to a data bus and an address bus (collectively can be referred to as a data bus) of a microprocessor. Further, 32-bit data is used by a number of standardized local buses such as a VL-bus (VESA Local bus) and a peripheral component interconnect (PCI) bus. Further, use of 32-bit data is state-of-the-art in embedded controllers.

However, an advanced technology attachment (ATA) standard sets the number of bits of an interface between a host system (microprocessor system) and a peripheral storage device to be 16 bits. In this situation, a method of optimally interfacing data buses having different data bus widths is being studied.

For instance, an intermediate buffer can be used as an interface to optimally interface a host system and a peripheral device. In this case, the intermediate buffer needs a first-in first-out (FIFO) memory because the buses have different data widths. A write controller and a read controller are additionally required for data transfer. Therefore, use of an intermediate buffer increases the manufacturing cost of an embedded microprocessor system because of the cost of the FIFO memory.

Further, to connect a peripheral device having an N-bit data bus width to a host system having a 2N-bit data bus width, the data bus width of the host system can be reduced. However, this method requires the embedded microprocessor system to operate at maximum frequency of the peripheral interface, which increases the processing burden of the host system bus, thereby decreasing performance of real time applications.

### SUMMARY OF THE INVENTION

To solve the above-described problems, an object of the present invention is to provide an interface for devices having different data bus widths without using a first-in first-out (FIFO) memory, and a data transfer method using this interface.

Additional objects and advantages of the invention will be set forth in part in the description which follows and, in part, will be obvious from the description, or may be learned by practice of the invention.

### BRIEF DESCRIPTION OF THE DRAWINGS

The above and other objects and advantages of the present invention will become more apparent by describing in detail preferred embodiments thereof with reference to the attached drawings in which:

FIG. 1 is a block diagram of a data processing system according to an embodiment of the present invention;

FIG. 2 is a circuit diagram showing an interface according to an embodiment of the present invention;

FIG. 3 is a detailed circuit diagram showing an outbound register shown in FIG. 2;

FIG. 4 shows states of a state machine of a read controller and transitions of the states, according to an embodiment of the invention;

FIG. 5 shows a first embodiment of a state change according to the state machine of FIG. 4;

FIG. 6 shows a second embodiment of a state change according to the state machine of FIG. 4;

FIG. 7 shows a third embodiment of a state change according to the state machine of FIG. 4;

FIG. 8 shows states of a state machine of a pre-fetch controller and transitions of the states, according to an embodiment of the invention;

FIG. 9 shows states of a state machine of a write controller and transitions of the states, according to an embodiment of the invention; and

FIG. 10 shows states of a state machine of a send controller and transitions of the states, according to an embodiment of the invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

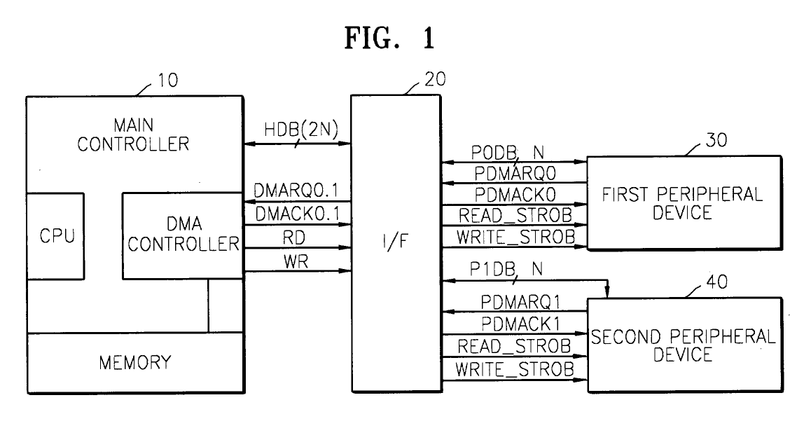

Referring to FIG. 1, a data processing system according to an embodiment of the present invention includes a main controller 10, an interface 20 and peripheral devices 30 and 40. This invention introduces just the two peripheral devices 30 and 40 for the convenience of explanation. However, it is apparent that this invention can be applied to a data processing system including N (N denotes a natural number) peripheral devices.

The data transfer between the main controller 10 and the peripheral devices 30 and 40 is accomplished through direct memory access (DMA). Thus, the data processing system described below is basically controlled by DMA signals, which are generated by the main controller 10 and the peripheral devices 30 and 40.

The input of data output from the peripheral device 30 to the main controller 10 is referred to as “reading” or “a reading operation.” The input of the data output from the main controller 10 to the peripheral device 40 is referred to as “writing” or “a writing operation.” A reading operation and a writing operation can be performed simultaneously. The peripheral device 30 can be a scanner, and the peripheral device 40 can be a storage device, such as a hard disk.

The main controller 10 includes a central processing unit (CPU), a DMA controller and a memory. The interface 20 receives DMA acknowledge signals DMACK0 and DMACK1, a write command signal WR and a read command signal RD, which are output from the main controller 10, and receives DMA request signals PDMARQ0 and PDMARQ1, which are output from the peripheral devices 30 and 40, respectively. Therefore, the interface 20 receives the first peripheral device DMA request signal PDMARQ0 from the first peripheral device 30 and receives the second peripheral device DMA request signal PDMARQ1 from the first peripheral device 40.

The interface 20 outputs DMA request signals DMARQ0 and DMARQ1 to the main controller 10 through two different channels, respectively. The interface 20 outputs a first peripheral device DMA acknowledge signal PDMACK0, a write strobe signal WRITE_STROB and a read strobe signal READ_STROB to the first peripheral device 30. The interface 20 also outputs a second peripheral device DMA acknowledge signal PDMACK1, a write strobe signal WRITE_STROB and a read strobe signal READ_STROB to the second peripheral device 40.

A host data bus (HDB), which electrically connects the main controller 10 and the interface 20, has a data width of M (M is equal to 2N, and N denotes a natural number) bits, and each peripheral data bus P0DB and P1DB, which connects the interface 20 and the peripheral devices 30 and 40, has a data width of N bits. The interface 20 is bi-directional.

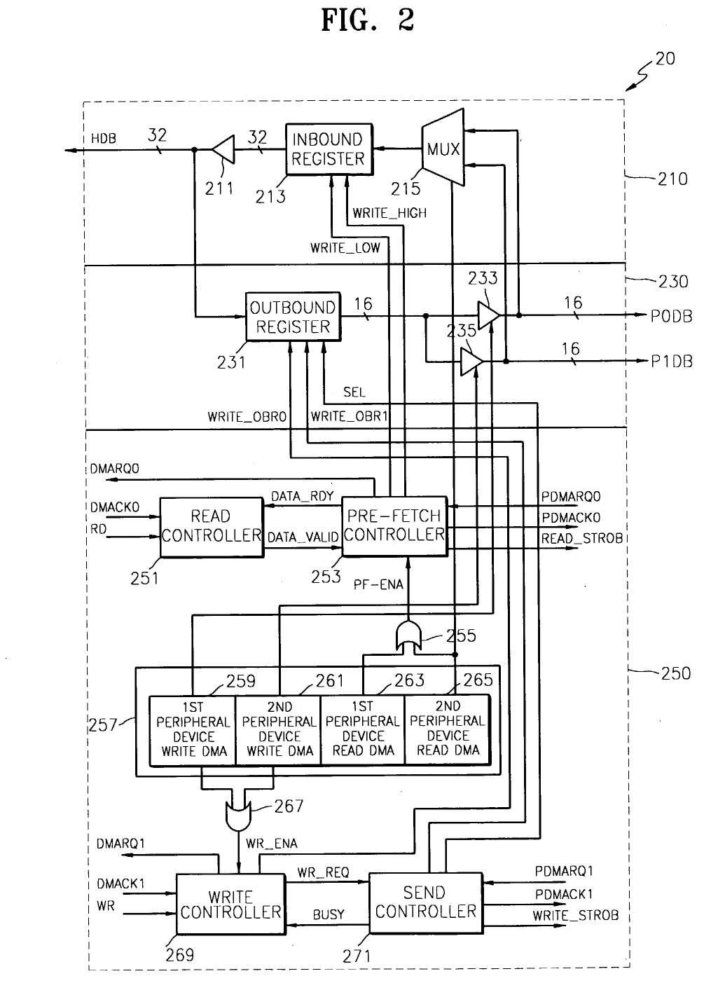

For the convenience of explanation, it is assumed in the embodiment of FIG. 2 that the width of the host data bus HDB is 32 bits and the width of each peripheral data bus P0DB and P1DB is 16 bits. That is, 32 bit data is transferred from the main controller 10 to the interface 20 through the host data bus HDB or from the interface 20 to the main controller 10 through the host data bus HDB. The 16 bit data is transferred from the interface 20 to the peripheral devices 30 and 40 through the peripheral data buses P0DB and P1DB, respectively.

FIG. 2 is a circuit diagram showing an interface 20 in detail, according to an embodiment of the present invention. The interface 20 includes first and second conversion circuits 210 and 230 and a control signal generation circuit 250. The first conversion circuit 210 includes a selection circuit 215, an inbound register 213 and an output buffer 211. The first conversion circuit 210 converts N-bit data into M-bit (e.g., M=2N) data and outputs the converted data to the host data bus HDB.

A multiplexer can be used as the selection circuit 215, which selectively outputs the data on the first peripheral data bus P0DB or the data on the second peripheral data bus P1DB to the inbound register 213 in response to a first control signal, which is output from a second peripheral device read DMA 265. The data on the first peripheral data bus P0DB or the data on the second peripheral data bus P1DB is N bits.

The inbound register 213 outputs the N-bit output signal of the selection circuit 215 to the output buffer 211 in response to first and second read control signals WRITE_LOW and WRITE_HIGH. The inbound register 213, which is configured by cascading registers of N-bit data widths, receives N-bit data, which is output from the selection signal 215, and transfers 2N-bit data to the output buffer 211. The output buffer 211, which typically is a tri-state buffer, buffers the 2N-bit output signal of the inbound register 213 and transfers the buffered 2N-bit output signal to the host data bus HDB.

The second conversion circuit 230 includes an outbound register 231 and first and second input buffers 233 and 235. The second conversion circuit 230 converts the 2N-bit data into N-bit data and outputs the N-bit data on the first or second peripheral data buses P0DB, P1DB, respectively, to the first or second peripheral devices 30 or 40.

FIG. 3 is a detailed circuit diagram of the outbound register 231 shown in FIG. 2, according to an embodiment of the invention. As shown in FIG. 3, the outbound register 231 includes first and second registers 2311 and 2313 and a selection circuit 2315. The first register 2311 latches 2N-bit (e.g., 32 bits) data in response to a first write control signal WRITE_OBR0, which is output from a write controller 269 of FIG. 2. The second register 2313 latches an output signal of the first register 2311 in response to a second write control signal WRITE_OBR1, which is output from a send controller 271, and outputs a result signal to the selection circuit 2315.

The selection circuit 2315 outputs N upper bits (e.g., 16-bits) or N lower bits (e.g., 16-bits) out of the bits of the output signal of the second register 2313 to the first and second input buffers 233 and 235 of FIG. 2 in response to a selection signal SEL. Therefore, the selection circuit 2315 in FIG. 3 is controlled by the selection signal SEL. The selection signal SEL is generated by the send controller 271 in FIG. 2 (i.e., second selection signal in claims 7 and 12, and also the selection signal in claim 18). In this way, the outbound register 231 converts the 2N-bit (e.g., 32-bit) data, which is output from the main controller 10, into N-bit (e.g., 16-bit) data in response to the write control signals WRITE_OBR0 and WRITE_OBR1 and outputs a result data to the first and second input buffers 233 and 235.

Referring back to FIG. 2, a tri-state buffer can be used as the first and second input buffers 233 and 235. The first input buffer 233 buffers the output signal of the outbound register 231 in response to a fourth control signal, which is output from the first peripheral device write DMA 259, and transfers the buffered output signal to the first peripheral data bus P0DB. The second input buffer 235 buffers the output signal of the outbound register 231 in response to a third control signal, which is output from the second peripheral device write DMA 261, and transfers the buffered output signal to the second peripheral data bus P1DB.

The control signal generation circuit 250 includes a read controller 251, a pre-fetch controller 253, a command register 257, a write controller 269, a send controller 271 and two logic gates 255 and 267. The read controller 251 outputs a data read request signal DATA_VALID to the pre-fetch controller 253 in response to a read command RD, which is input from the main controller 10, and a data ready signal DATA_RDY, which is input from the pre-fetch controller 253. The read controller 251 controls read-out of data, which is output from the first peripheral device 30, by controlling operations of the pre-fetch controller 253.

The pre-fetch controller 253 outputs read control signals WRITE_LOW and WRITE_HIGH to the inbound register 213 in response to a pre-fetch enable signal PF_ENA, which is input from the command register 257, and the data read request signal DATA_VALID, which is input from the read controller 251.

The pre-fetch controller 253 also outputs a first peripheral device DMA request signal DMARQ0 to the main controller 10 and an inactivated data ready signal DATA_RDY to the read controller 251, in response to the data read request signal DATA_VALID.

The command register 257 includes four command DMAs 259, 261, 263 and 265. In case the first and second peripheral devices 30 and 40 are a scanner and a hard disk, respectively, to transfer data from the main controller 10 to the second peripheral device 40, the first peripheral device write DMA 259 outputs an inactivated command signal to the first input buffer 233, and the second peripheral device write DMA 261 outputs an activated command signal to the second input buffer 235. Therefore, the second input buffer 235 can transfer the output signal of the outbound register 231 to the second peripheral data bus P1DB. More particularly, the peripheral devices 30 and 40 can be any known peripheral devices and can appear in any combination of read and write capabilities. However, FIG. 2 omits WRITE_STROB for the first peripheral device and READ_STROB for the second peripheral device to reduce description complexity. In full realization of the system, the signals PDMARQ(1:0), PDMACK(1:0), READ_STROB and WRITE_STROB are switched between the peripheral devices in a manner shown for N-bit data buses P0DB and P1DB, namely in a response to a command written into the command register 257 (i.e., third selection signal in claims 7 and 12). Therefore, in a case the first peripheral device 30 is not a scanner and can receive data, similarly, data can be transferred from the main controller 10 to the first peripheral device 30 via an inactivated command signal from the second peripheral device write DMA 261 to the second input buffer 233 and an activated command signal from the first peripheral device write DMA 259 to the first input buffer 235.

The first peripheral device read DMA 263 outputs an activated command signal to a logic gate 255, and the second peripheral device read DMA 265 outputs an inactivated command signal to the logic gate 255 and the selection circuit 215. Thus, the selection circuit 215 outputs data, which is input from the first peripheral device 30, to the inbound register 213. Similarly, via an inactivated command signal from the first peripheral device read DMA 263 to the logic gate 255 and an activated command signal from the second peripheral device read DMA 265 to the logic gate 255 and the selection circuit 215, data can be transferred from the second peripheral device 40 to the controller 10 via the inbound register 213.

The write controller 269 outputs a write request signal WR_REQ to the send controller 271 and the first write control signal WRITE_OBR0 to the outbound register 231, in response to a write command signal WR, a busy signal BUSY, and a write enable signal WR_ENA, which is output by the command register 257. Regarding the PF_ENA and WR_ENA control signals output by the command register 257, typically the command register 257 can receive a command (e.g., a 4-bit command) output from the main controller 10 in FIG. 1 using a common line of a computer system's read-write procedure. Typically, such a read-write procedure requires circuitry comprising an address decoder to produce a chip select signal, a read strobe signal and a write strobe signal. The command for the command register 257 is transferred through the HDB to which the command register 257 in FIG. 2 is also connected.

The send controller 271 outputs the busy signal BUSY to the write controller 269, the second write control signal WRITE_OBR1 to the outbound register 231, and the write strobe signal WRITE_STROB and the second peripheral device DMA acknowledge signal PDMACK1 to the second peripheral device 40, in response to the write request signal WR_REQ and the second peripheral device DMA request signal PDMARQ1. Therefore, the send controller 271 outputs the output signal of the outbound register 231 to the second peripheral device 40 in response to the write request signal WR_REQ and the second peripheral device DMA request signal PDMARQ1. In case the first peripheral device 30 is not a scanner and can receive data, similarly, data can be transferred via the outbound register 231 to the first peripheral device 30 according to operations of the write controller 269 and the send controller 271.

The logic gate 255 outputs the pre-fetch enable signal PF_ENA to the pre-fetch controller 253 in response to the output signal of the first peripheral device read DMA 263 and that of the second peripheral device read DMA 265. The logic gate 255 can be formed by an OR gate. A logic gate 267 outputs the write enable signal WR_ENA to the write controller 269 in response to the output signal of the first peripheral device write DMA 259 and that of the second peripheral device write DMA 261. The logic gate 267 can be formed by an OR gate. Therefore, a writing operation is controlled by the write controller 269 and the send controller 271, and a reading operation is controlled by the read controller 251 and the pre-fetch controller 253.

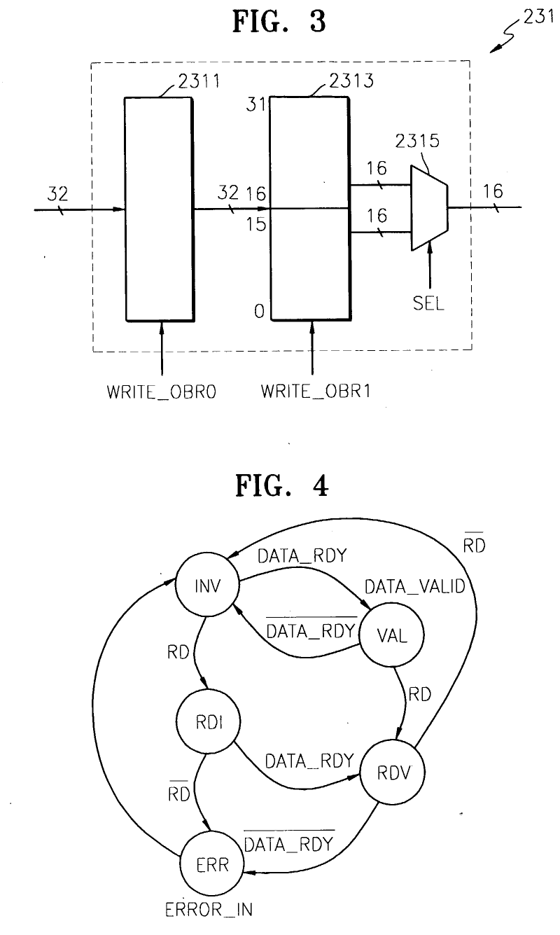

FIG. 4 shows states of a state machine of a read controller and transitions of the states, according to an embodiment of the invention. Referring to FIG. 4, the read controller 251 has the following states. INV, which denotes a data invalid state, shows the initial state of the read controller 251. INV occurs after a read cycle is completed.

VAL denotes a data valid state. The state VAL occurs after the pre-fetch controller 253 reads twice N-bit data on the peripheral data buses P0DB or P1DB and outputs a data read ready signal DATA_RDY to the read controller 251.

In a read operation, a signal that controls read rate and strobes a data can be named read enable or command signal, usually namely read signal. Therefore, RDI denotes a data invalid read state, and occurs when a read enable (command) signal RD is activated before the data read ready signal DATA_RDY is activated. RDV denotes a data valid read state, and occurs when a read command signal RD is activated in the VAL state. ERR denotes an error state, and occurs when the read command signal RD is invalidated while reading out data.

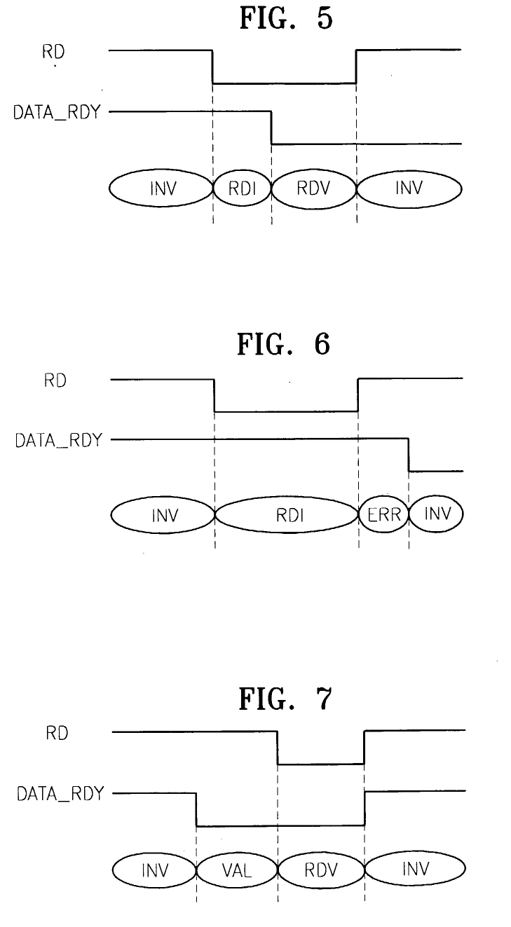

FIG. 5 shows a first embodiment of a state change according to the state machine of FIG. 4. Referring to FIGS. 4 and 5, the read command signal RD and the data read ready signal DATA_RDY are inactivated at a high logic. Conversely, the read command signal RD and the data read ready signal DATA_RDY are active at a low logic. In particular, in the example embodiment, inactivated signals are high logic and activated signals are low logic.

Referring to FIG. 5, when the read command signal RD and the data read ready signal DATA_RDY are inactive, that is, in logic high, the read controller 251 keeps the INV state. However, when the read command signal RD goes logic low, the read controller 251 transits from the INV state to the RDI state. Further, when the data read ready signal DATA-RDY goes logic low while the DATA_RDY is also logic low (i.e., both RD and DATA_RDY are active), the read controller 251 transits from the RDI state to the RDV state. Further, when the read command RD goes logic high while the DATA_RDY is logic low, then the read controller 251 transits from the RDV state to the INV state.

FIG. 6 shows a second embodiment of a state change according to the state machine of FIG. 4. Referring to FIGS. 4 and 6, the read controller 251 keeps the INV state when the read command signal RD and the data read ready signal DATA_RDY are inactive. When the read command signal RD goes logic low, the read controller 251 transits from the INV state to the RDI state. When the read command signal RD goes logic high while the DATA_RDY is logic high, the read controller 251 transits from the RDI state to the ERR state and the read controller 251 outputs an error signal ERROR_IN. When the data read ready signal DATA_RDY goes logic low while the RD is logic high, the read controller 251 transits from the ERR state to the INV state.

FIG. 7 shows a third embodiment of a transition of the states of the state machine of FIG. 4. Referring to FIGS. 4 and 7, the initial state of the read controller 251 is the INV state. When the data read ready signal DATA_RDY goes logic low, the read controller 251 transits from the INV state to the VAL state. When the read command signal RD goes logic low, the read controller 251 transits from the VAL state to the RDV state. When the read command signal RD and the data read ready signal DATA_RDY go to logic high, the read controller 251 transits from the RDV state to the INV state.

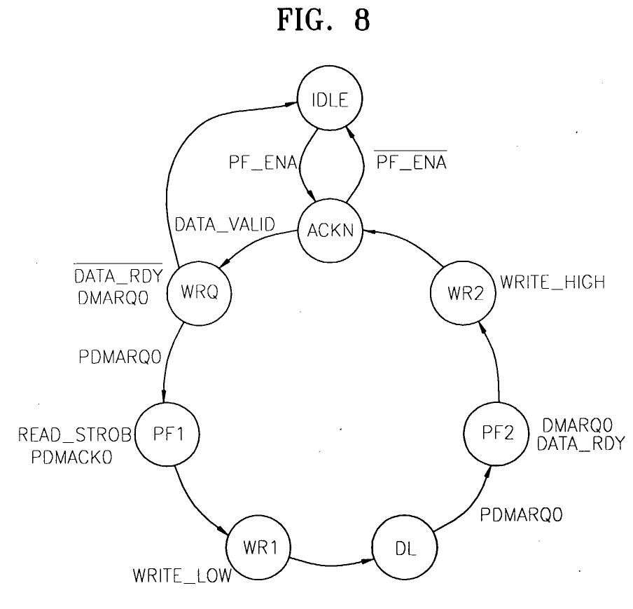

FIG. 8 shows states of a state machine of a pre-fetch controller, and transitions of the states, according to an embodiment of the invention. Referring to FIG. 8, the pre-fetch controller 253 has the following states. IDLE denotes an idle state of the pre-fetch controller 253. The pre-fetch controller 253 has the IDLE state as its initial state where the pre-fetch controller 253 has no commands. ACKN denotes an acknowledge state of the pre-fetch controller 253. The pre-fetch controller 253 transits from the IDLE state to the ACKN state in response to a pre-fetch enable signal PF_ENA and outputs an inactivated first peripheral device DMA acknowledge signal PDMACK0.

WRQ denotes a waiting state. The pre-fetch controller 253 waits for the first peripheral device DMA request signal PMDARQ, which is input from the first peripheral device 30, in the WRQ state. PF1 denotes a first pre-fetch state. In the PF1 state, the pre-fetch controller 253 pre-fetches a first data word (e.g., 16 bits) from the first peripheral device 30. WR1 denotes a first write state. In the WR1 state, the pre-fetch controller 253 writes the pre-fetched first data word to the inbound register 213.

DL denotes a delay state. PF2 denotes a second pre-fetch state. In the PF2 state, the pre-fetch controller 253 pre-fetches a second data word (e.g., 16 bits) from the first peripheral device 30. WR2 denotes a second write state. In the WR2 state, the pre-fetch controller 253 writes the pre-fetched second data word to the inbound register 213. In the WR2 state, after the second data word is written to the inbound register 213, the pre-fetch controller 253 goes to the ACKN state at which time if the pre-fetch signal PF_ENA is inactivated, the pre-fetch controller 253 goes to the IDLE state.

More particularly, control signals control states of the read controller 251 and the pre-fetch controller 253 as follows. The pre-fetch controller 253 keeps the IDLE state in its initial stage and transits from the IDLE state to the ACKN state in response to the pre-fetch enable signal PF_ENA, which is output from the command register 257. The pre-fetch controller 253 transits from the ACKN state to the WRQ state in response to a data read request signal DATA_VALID, and outputs the inactivated data ready signal DATA_RDY to the read controller 251 and outputs the first DMA request signal DMARQ0 to the main controller 10.

The pre-fetch controller 253 transits from the WRQ state to the PF1 state in response to the first peripheral device DMA request signal PDMARQ0, and outputs the read strobe signal READ_STROB and the first peripheral device DMA acknowledge signal PDMACK0 to the first peripheral device 30.

The pre-fetch controller 253 transits from the PF1 state to the WR1, generates a first read control signal WRITE_LOW and outputs the first read control signal WRITE_LOW to the inbound register 213. Thus, the N-bit data on the data bus P0DB is written to the first register of the inbound register 213. The pre-fetch controller 253 transits from the DL state to the PF2 state and outputs a second DMA request signal DMARQ0 to the main controller 10 and the data ready signal DATA_RDY to the read controller 251.

The pre-fetch controller 253 transits from the PF2 state to the WR2 state, generates a second read control signal WRITE_HIGH and outputs the second read control signal WRITE_HIGH to the inbound register 213. Thus, another N-bit data on the data bus P0DB is written to the second register of the inbound register 213.

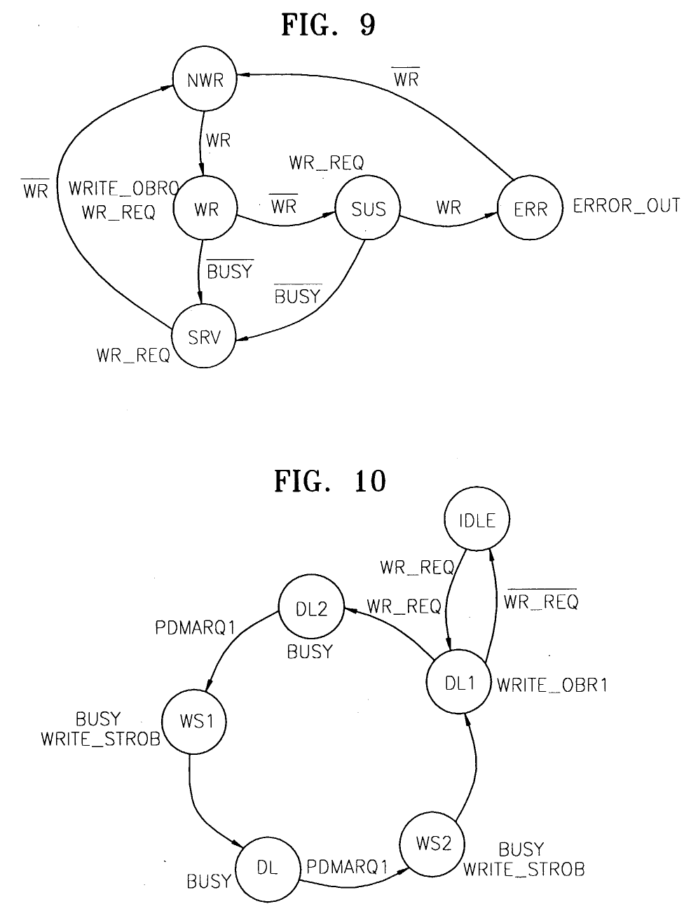

FIG. 9 shows states of a state machine of a write controller and transitions of the states, according to an embodiment of the invention. Referring to FIG. 9, the write controller 269 has the following states. NWR denotes an initial state of the write controller 269. WR denotes a state where the write controller 269 performs a writing operation. SRV denotes an operation state of the write controller 269. SUS denotes a suspend state of the write controller 269. ERR denotes an error state of the write controller 269.

FIG. 10 shows states of a state machine of a send controller and transitions of the states, according to an embodiment of the invention. Referring to FIG. 10, the send controller 271 has the following states. IDLE denotes an initial state of the send controller 271. DL1 denotes a first delay state of the send controller 271. DL2 denotes a second delay state of the send controller 271. WS1 denotes a first write strobe state. DL denotes a third delay state of the send controller 271. WS2 denotes a second write strobe state.

Referring to FIGS. 2, 3, 9 and 10, the write controller 269 transits from the initial state NWR to the WR state in response to the write controller enable signal WR_ENA and the write enable signal WR, generates the write request signal WR_REQ and outputs the write request signal WR_REQ to the send controller 271. In the WR state, the write controller 269 also outputs the DMA request signal DMARQ1 to the main controller 10 and outputs the first write control signal WRITE_OBR0 to the first register 2311 of the outbound register 231. The first register 2311 of FIG. 3 latches the data of the host data bus HDB in response to the first write control signal WRITE_OBR0.

The send controller 271 transits from the IDLE state to the first delay state DL1 in response to the write request signal WR_REQ and generates the second write control signal WRITE_ORB1. Thus, in the first delay state DL1 of the send controller 271, the second register 2313 of the outbound register 231 latches the output data of the first register 2311 in response to the second write control signal WRITE_ORB1. In the first delay state DL1, the send controller 271 starts processing.

The send controller 271 transits from the first delay state DL1 to the second delay state DL2 in response to the write request signal WR_REQ and outputs the busy signal to the write controller 269. The busy signal indicates that the outbound register 231 stores data. Then the send controller 271 transits from the second delay state DL2 to the first write strobe state WS1 in response to a first peripheral device DMA request signal PDMARQ1 and outputs the busy signal to the write controller 269 and a first write strobe signal WRITE_STROB to the second peripheral device 40.

In the third delay state DL, the send controller 271 outputs the busy, signal to the write controller 269. Then the send controller 271 transits from the third delay state DL to the second write strobe state WS2 in response to a second peripheral device DMA request signal PDMARQ1 and outputs the busy signal to the write controller 269 and a second write strobe signal WRITE_STROB to the second peripheral device 40, thereby allowing the second peripheral device 40 to read the N-bit data from the outbound register 231 on the peripheral data bus P1DB. More particularly, referring to FIGS. 2, 3 and 10, the selection signal SEL has a value which selects the lower 16 bits (0:15) of data output from the second register 2313 when the send controller 271 is in one of the DL1, DL2, or WS2 states. In FIG. 10, when in other states of IDLE, WS1, or DL, the send controller 271 generates the selection signal SEL to select higher bits (16:31) of data output from the second register 2313.

Accordingly, the present invention provides in a computer system an interface interfacing a plurality of first data buses each having an N-bit data width and a second data bus having a 2N-bit data width. The interface includes a selection circuit and first and second conversion circuits. The selection circuit outputs the data on a data bus selected from the first data buses in response to a selection signal. The first conversion circuit pre-fetches first and second N-bit data on the selected data bus in response to a read control signal and transfers 2N-bit data comprised of the pre-fetched first and second N-bit data to the second data bus. The second conversion circuit converts the 2N-bit data on the second data bus into N-bit data in response to a write control signal and transfers the N-bit data to a data bus selected from the first data buses. Although, the example embodiments describe interfacing a 2N-bit width bus with an N-bit width bus, the present invention is not limited to such configuration. According to the invention, N-bit width buses (e.g., byte, word, etc.) can be interfaced with an M-bit width bus (M=K×N, K is a natural number) via direct memory access control signals controlling conversion circuits and the conversion circuits performing K transfer operations (K=M/N). More particularly, the present invention interfaces devices having different bus widths using DMA.

Although the above example embodiments in FIGS. 4-10 describe data transfer from a scanner as the first peripheral device to the main controller 10 and data transfer from the main controller to a hard disk as the second peripheral device, the present invention is not limited to such configuration and data can be transferred to/from each peripheral device according to the interface 20 of the invention and transfer methods thereof, thereby interfacing N and 2N data buses. The above-described interface for devices having different data bus widths and the data transfer method using the interface reduce the unit cost of an embedded microprocessor system. In addition, the above-described interface and the data transfer method using the interface improves the performance of an embedded microprocessor system by reducing the data transfer frequency on a host data bus.

While this invention has been particularly shown and described with reference to a preferred embodiment thereof, it will be understood by those skilled in the art that various changes in form and details may be made therein without departing from the spirit and scope of the invention as defined by the appended claims and their equivalents.

What is claimed is:

1. An interface interfacing a first data bus of an N-bit data width and a second data bus of a 2N-bit data width, the interface comprising:
a first conversion circuit pre-fetching first N-bit data and second N-bit data on the first data bus in response to read control signals and transferring 2N-bit data comprised of the pre-fetched first and second N-bit data to the second data bus; and
a second conversion circuit converting the 2N-bit data on the second data bus into N-bit data in response to write control signals and transferring the N-bit data to the first data bus.

2. The interface of claim 1, wherein the data transfer from the first data bus to the second data bus is performed through direct memory access (DMA).

3. The interface of claim 1, wherein the data transfer from the second data bus to the first data bus is performed through direct memory access (DMA).

4. An interface interfacing a plurality of first data buses each having an N-bit data width and a second data bus having a 2N-bit data width, the interface comprising:
a first selection circuit outputting the data on a data bus selected from the first data buses in response to a first selection signal;
a first conversion circuit pre-fetching first and second N-bit data on the selected data bus in response to read control signals and transferring 2N-bit data comprised of the pre-fetched first and second N-bit data to the second data bus; and
a second conversion circuit converting the 2N-bit data on the second data bus into N-bit data in response to write control signals and transferring the N-bit data to a data bus selected from the first data buses.

5. The interface of claim 4, wherein the data transfer from the first data bus to the second data bus is performed through direct memory access (DMA).

6. The interface of claim 4, wherein the data transfer from the second data bus to the first data bus is performed through direct memory access (DMA).

7. The interface of claim 4, wherein the second conversion circuit includes:
a first register connected to the second data bus, the first register latching the 2N-bit data on the second data bus in response to a first write control signal;
a second register dividing an output signal of the first register by N-bits in response to a second write control signal and latching each of the divided N-bit data;
a second selection circuit selectively outputting the latched N-bit data from the second register in response to a second selection signal; and
a buffer outputting the output data of the second selection circuit to a data bus selected from the first data buses in response to a third selection signal.

8. An interface interfacing a first data bus of an N-bit data width and a second data bus of a 2N-bit data width, the interface comprising:
a first conversion circuit pre-fetching first N-bit data on the first data bus in response to a first read control signal and second N-bit data on the first data bus in response to a second read control signal and transferring 2N-bit data comprised of the pre-fetched first and second N-bit data to the second data bus; and
a second conversion circuit dividing the 2N-bit data on the second data bus by N bits, latching the divided N-bit data in response to a write control signal and transferring each of the latched N-bit data to the first data bus.

9. The interface of claim 8, wherein the data transfer from the first data bus to the second data bus is performed through direct memory access (DMA).

10. The interface of claim 8, wherein the data transfer from the second data bus to the first data bus is performed through direct memory access (DMA).

11. An interface comprising:
a first data bus having an N-bit data width;
a second data bus having an N-bit data width;
a first selection circuit selecting the data on the first data bus or the data on the second data bus in response to a first selection signal;
a first conversion circuit pre-fetching the output signals of the selection circuit in response to read control signals and transferring 2N-bit data comprised of the pre-fetched data to a third data bus having a 2N-bit data width; and
a second conversion circuit dividing 2N-bit data on the third data bus by N-bit data in response to write control signals and transferring the divided N-bit data to either the first data bus or the second data bus.

12. The interface of claim 11, wherein the second conversion circuit includes:
a first register connected to the third data bus, the first register latching the 2N-bit data on the third data bus in response to one of the write control signals;
a second register dividing the output signal of the first register by N bits in response to another of the write control signals and latching each of the divided N-bit data;
a second selection circuit selectively outputting the latched N-bit data to the second register in response to a second selection signal; and
two input buffers each transferring the output data of the second selection circuit to the first or second data bus in response to a third selection signal.

13. The interface of claim 11, wherein the data transfer from the first or second data bus to the third data bus is performed through direct memory access (DMA).

14. The interface of claim 11, wherein the data transfer from the third data bus to the first or second data bus is performed through direct memory access (DMA).

15. A method of transferring the data on a first data bus of an N-bit data width or a second data bus of an N-bit data width to a third data bus, the method comprising:
outputting the data on the first or second data bus in response to a selection signal; and
pre-fetching first and second N-bit data on the selected first or second data bus in response to read control signals and transferring M-bit data comprised of the pre-fetched first and second N-bit data to the third data bus.

16. The method of claim 15, wherein M denotes 2N.

17. The method of claim 15, wherein the data transfer from the first data bus to the third data bus is performed through direct memory access (DMA).

18. A method of transferring the data on a first data bus of an M-bit data width to a second data bus of an N-bit data width or a third data bus of an N-bit data width, the method comprising:
latching the M-bit data on the first data bus in response to a first write control signal;
dividing the latched M-bit data latched by N bits, latching each of the divided N-bit data in response to a second write control signal and selectively outputting the latched N-bit data in response to a selection signal; and
transferring the output latched N-bit data to the first or second data bus in response to a control signal.

19. The method of claim 18, wherein M denotes 2N.

20. The method of claim 18, wherein the data transfer from the first data bus to the second or third data bus is performed through direct memory access (DMA).

21. A computer system with an M-bit system bus and N-bit peripheral buses, comprising:
direct memory access control signals controlling conversion circuits interfacing the M-bit system bus with the N-bit peripheral buses.

22. The computer system of claim 21, further comprising a write controller and a read controller; and
wherein the direct memory access control signals control the write controller to control one of the conversion circuits to convert the M-bit data from the system bus to the N-bit data of the peripheral buses and the direct memory access control signals control the read controller to control another of the conversion circuits to convert the N-bit data from the peripheral buses to the M-bit data of the system bus.

23. A computer system, comprising:
an M-bit system bus;
N-bit peripheral buses; and
an interface interfacing the M-bit system bus and the N-bit peripheral buses without using a first-in-first-out memory.

24. A computer system, comprising:
an M-bit system bus;
N-bit peripheral buses; and
an interface interfacing the M-bit system bus and the N-bit peripheral buses using direct memory access control signals.
